(19) United States
(12) Patent Application Publication
(10) Pub. No.: US 2007/0150369 A1
(43) Pub. Date: Jun. 28, 2007

(54) Method and system for determining the optimal travel route by which customers can purchase local goods at the lowest total cost

(76) Inventor: Michael A. Zivin, Chicago, IL (US)

Correspondence Address: NORMAN H. ZIVIN;Cooper & Dunham LLP, 1185 Avenue of the Americas, New York, NY, 10036, US

(21) Appl. No.: 11/517,973

(22) Filed: Sep. 8, 2006

Related U.S. Application Data
(60) Provisional application No. 60/754,776, filed on Dec. 28, 2005.

(51) Int. Cl. G06Q 30/00

(52) U.S. Cl. 705/26

(57) ABSTRACT

A method and system for providing customers with means to determine a) how far the customer should be willing to travel to a vendor to purchase locally sold goods and b) what routes the customer should take to minimize his or her total costs. Customers use an Internet search engine to find products or services that they are interested in purchasing in their local area. The search results provide a list of goods along with their current price and store location. Customers select one or more goods they are interested in purchasing and add these goods to a shopping list. A recommendation is provided based on variables such as the customer's estimated value of time, traffic conditions, gas prices, parking fees, automobile miles per gallon, the difference in prices between stores, or other relevant variables. The recommendation informs the customers as to vendors at which he or she should purchase goods and the order in which the locations should be visited so as to minimize total purchase costs.

### CROSS REFERENCE TO RELATED APPLICATION

This application claims the benefit of U.S. Provisional Application No. 60/754,776, filed Dec. 28, 2005.

### FIELD OF THE INVENTION

This invention relates to a method and system for performing purchase transactions over a general access computer network and, in particular, to a system and method that incorporates geography and location into purchasing decisions.

### BACKGROUND OF THE INVENTION

It is well known that customers have less free time than in the past to manage household responsibilities. According to a recent Economic Policy Institute study, in 2001 the average American family worked 11% more hours (111 hours) than it did in 1975. Despite having less leisure time, customers are spending more time shopping than ever before. In the past few decades, the amount of time customers spent shopping for local goods has increased by nearly 200%. According to the U.S. Government's Center for Transportation Analysis, the average American drove 2,567 miles on shopping trips in 1983 and over 5,188 miles in 2001. In addition, the average number of miles per trip increased nearly 50%.

With less leisure time, most customers would like to reduce the amount of time they spend shopping for everyday products and services in their local neighborhoods. The positive trend towards online shopping shows that customers like the convenience and prices they find for online goods. However, in the offline, local world, customers are using other tactics to save time and money. Customers increasingly prefer to visit only a few large vendors for the majority of their purchases. The rapid growth of large discounters shows that customers are consolidating their purchases at fewer vendors. In addition, customers are willing to change their purchase behavior to save on purchases. The growth of wholesale clubs shows that customers are willing to travel to out-of-the-way locations and buy larger quantities of goods to save money.

While consolidating purchases and buying in bulk might work for mass merchandised products, there is no equivalent for the purchase of local services and goods such as haircuts, eye examinations, or car washes. These are often provided by much smaller vendors such as mom-and-pop businesses. Customers must travel to many different vendors and rarely receive discounts for these services.

As customers become more sophisticated in their purchasing strategies, so too have businesses. Manufacturers, retailers and service shops are using a variety of pricing models. “Price segmentation” is a marketing term used to describe the process of segmenting customers by characteristics such as willingness to pay, need for convenience, and volume purchases. For example, warehouse clubs use price segmentation to provide low prices for customers willing to purchase products in bulk from out-of-the-way locations. Most customers are unaware of price segmentation strategies, but realize that some customers pay more than other customers for the same goods.

It is increasingly more difficult for customers to determine if they are getting the lowest price for a product or service. The wide variety of pricing schemes and price segmentation strategies means that some customers may never get the opportunity to buy a good at the same price as another set of customers. For example, female customers may be sent coupons in the mail for 10% off at a particular vendor but male customers never receive the coupon. Effectively, customers do not have transparency into prices, thus making it difficult for them to make educated decisions on what goods to buy, at what time and from what vendor.

Price transparency is further exacerbated by the difficulty of comparing similar products sold by different vendors. Products and services are often sold in different quantities, for examples, a 12 oz can of soda versus a 48 oz bottle of the same soda or a 60 minute massage versus a 90 minute massage. The difference in quantity makes it difficult for customers to know if they are getting a good deal.

The purchase price of goods is only one component of the total cost of the goods. When buying goods online, the item has a price to which are added shipping costs and taxes. When shopping offline, customers often do not factor in the many other variables that contribute to the total cost of buying goods. These variables might include:
Travel costs—such as for fuel, time spent on the road, wear and tear on the automobile, or time waiting for public transportation
Sales tax—different rates for purchasing in one county versus another
Opportunity costs—the lower prices one may have paid for the same goods at a different location
Search costs—the amount of time one spends searching for vendors that carry the goods at the prices they are willing to buy them
Discounts—price segmentation has meant that consumers receive many different types of discounts that should be factored into purchasing decisions

When evaluating which goods to buy and the vendors they should be bought from, customers must make tradeoffs which often do not result in the lowest total price for the customer. For example, when factoring in time costs and fuel costs, some customers may be surprised to learn that traveling 40 miles to a warehouse club might not result in any cost savings over buying the goods from local vendors.

Rarely are customers aware of the many variables that ideally should be factored into everyday purchasing decisions. Coupled with the lack of price transparency, customers are rarely able to make educated purchasing decisions and are therefore unlikely to pay the lowest price for products and services.

The growing acceptance of wireless Internet access, portable computers and automobile navigation systems means that customers can make smarter shopping decisions. Services such as Google Maps and Mapquest and hardware such as Magellan navigation systems allow customers to determine how to optimally get from point A to point B. In addition, customers are increasingly using wireless devices to access local information such as weather reports and basic vendor information such as location and phone numbers.

Limited pricing information for many large vendors such as electronics retailers and department stores already may be available on wireless devices. However, what is needed is an offering that determines the optimal means by which customers should purchase such goods in a local area so as to minimize total purchase costs. It is not enough for customers to simply compare the price of a product at store A versus the same product at store B. The other aforementioned factors should be taken into account. The customer should be presented with a list of vendors which should be considered and the order in which one should make the purchases. For example, driving 10 miles across town during rush hour to purchase a $5.00 item might not be financially worthwhile if the same item can be purchased nearby for $6.00. While the cost of the item on a per unit basis might be higher, the total purchase likely will be lower.

These types of decisions often are made by customers in their heads and without full information. Given the plethora of data feeds available (such as traffic feeds), pricing and vendor data, and customers' willingness to provide detailed information about themselves (such as their default zip code), it is desirable to create a system that determines the optimal means of purchasing goods and services in a local area at the lowest total cost.

### SUMMARY OF THE INVENTION

It is an object of the present invention to provide a method and system for purchasing goods and services in a local area.

It is a further object of the present invention to provide a method and system for purchasing goods and services at the lowest total cost.

To these and other ends, the system and method of present invention uses numerous data sources coupled with customer preferences, computer algorithms and visual displays to provide customers with an optimized shopping list. This shopping list is optimized such that customers can pay the lowest total price for goods particularly taking into account the customer's desire to spend the least amount of time shopping. In other words, the system finds the ideal balance between money saved and time costs.

In carrying out this invention, several purchasing problems are solved that no current system has solved. Chief among those is the ability to save customers time and money by giving customers greater price transparency so they can chose which vendors to patronize. Customers generally are not aware of small price differences between the identical products and services at different locations. This system provides a means by which customers can visually see the base price (the sticker price) and the total price of goods at different locations and easily eliminate vendors with prices the customer deems unacceptable.

In addition, customers have only a cursory understanding of why vendors price the same goods at different prices. For example, vendors in more remote locations may have lower prices due to lower rent and employee costs while vendors in highly trafficked areas may have steeper prices because of higher rent and employee costs. Again, this system allows consumers to see how variables such as convenience, customer service, and product selection might affect price. In some embodiments of the invention, customers will be able to see the vendors color coded based on their average prices relative to one another.

Consumers do not have a good sense for the total costs associated with purchasing a product or service in their local area. There are too many variables for an individual to consider and often it is not worth the effort to do this analysis manually in order to save a small amount of money. However, using databases and computing power, these calculations can be performed almost immediately with minimal time cost to the customer. While the savings a customer might get on a single shopping trip would be small, over time, these small savings would amount to large sums saved.

The system also provides the means by which customers can switch their purchasing decisions after they have embarked on a shopping trip, thereby saving them time. For example, if a vendor has run out of a product, a hair stylist has a backlog of customers, or traffic congestion develops, then the customer can be alerted and provided with alternate solutions in real-time. This alert can come in many forms. In one embodiment, the alert is presented on the customer's navigation system and an updated shopping list is presented. In another embodiment, the customer receives an email or text message to his or her mobile phone.

Customers often do not consider a vendor with which they are unfamiliar because that vendor may be in a less desirable location, the goods it sells are unknown, and/or the prices it offers are also unknown. For example, many customers may not be aware that a certain hair salon also sells a brand of shampoo at a lower cost than the local drugstore. The method and system of the present invention allows customers greater insight into the savings they might achieve by trying other vendors they have never patronized before. This also helps vendors by exposing them to new customers.

With the growing use of mapping and navigation systems, this invention allows for integration of shopping recommendations with location data. Customers would like to see the total price of various goods graphically integrated with mapping systems. Thus, in one embodiment of the invention, the total price for an eye examination, for example, can be shown along with a graphic depicting the vendor's physical store location. As the customer travels in his or her automobile, the prices for eye exams at far away locations can change, showing in real-time how distance affects the total price of an eye exam.

In addition, consumers often do not have a good sense for how a vendor's prices compare with the prices of competing vendors. Consumers typically have a feeling that one vendor is more expensive than another, but they have little hard evidence. For example, if one compared 30 products from supermarket A with the same 30 products from supermarket B, it could be determined that one supermarket is more or less expensive than the other. In essence, a consumer price index has been created. This system allows customers to compare the total price of a shopping list amongst locations. This information is then fed into an online mapping system or vehicle navigation system. The physical vendor locations are color coded according to how costly the goods are relative to other vendors. For example, expensive supermarkets are shaded red and inexpensive ones are shaded green.

This invention uses a large number of variables covering goods, vendors, locations, and consumer preferences to determine the optimal means by which consumers should buy goods in their local area.

Data on goods (products and services) is provided by vendors, third parties, or by customers. Product and service data might contain data points such as the price of the goods, manufacturer, package size, Universal Product Code (UPC), Manufacturer's Suggested Retail Price (MSRP), size, weight, duration (for services), identified product substitutes or complements, or any other relevant data.

Data on vendors is provided by the vendors themselves, third parties or customers. Vendor data might contain data points such as the vendor location (address or GPS coordinates), goods offered, prices, inventory levels, and business hours. Customer ratings of vendors are also collected. Customers can rate vendors on a variety of criteria such as quality, selection, convenience and service.

Customer data and preferences are also important. Customers provide information such as their location (by city, postal code, street address, or GPS coordinates), favorite vendors, vendors they dislike, working schedule, discount cards held, estimated time value of money, coupons held, and type of automobile.

In addition, other data points are used such as average gasoline prices in the area, traffic conditions, product rebates, and state and local tax rates. These data points may come from third party data feeds fed into the system from an external source which collects said disseminates such information.

One embodiment of the system is a search engine interface whereby customers can look up goods by name, description, category, vendor, location or other criteria. The system uses the customer's default or current location which either is provided by the customer or determined by the device the customer is using and has been transmitted to the system. The system then references its database of goods and returns the relevant matches for products and services based on commonly used Boolean and natural language search algorithms. The goods are included in the search results only if the goods are offered in the customer's local area. This is determined by searching each vendor in a specific radius. Customers may specify how far they are willing to travel. The vendor's radius is determined using the vendor's GPS coordinates, postal code, or address.

Once identified as being within reasonable proximity to the customer, the vendors are checked to see if they provide the requested goods, if the goods are in stock (in the case of a product), or if the vendor has availability (in case of a service). Vendors who have low ratings, as determined by the customer community, or who have been excluded by the customer are not included in the matches. Vendors who have been identified previously as “preferred vendors” are always included in the matches if they sell the requested goods and the goods are in stock or available.

Customers can view the goods and vendors that were identified by the system. Displayed is the price of the goods, with rebates, coupons or other cost savers subtracted from the base price. In addition, an estimated total cost is shown for each of the goods which factors in variables such as the cost of traveling to the vendor's location and time costs. These costs are often higher than simply the base price of the goods. Customers are also presented with substitute and complementary goods. For example, after searching for one brand, customers may be shown alternate brands or may be shown related products.

Customers can select the goods they would like to purchase and may add them to a shopping list along with the quantity of each of the goods they would like to purchase. Customers may also select the specific vendor locations at which they would like to purchase the goods or let the system determine this for them. For example, many customers have a preferred hair stylist and would not like to select a haircut at a different barber or salon. However, many customers would be willing to purchase goods from any vendor who can provide the goods at the lowest total cost. In this instance, the customer asks the system to optimize the shopping trip to determine how the goods could be purchased for the lowest total cost.

The system uses numerous variables to determine the optimal means of purchasing the goods for the lowest total cost. The optimization method is comprised of several steps:
Selection of the vendors and location (amongst the ones not eliminated by the customer) with preference given to those with:
   Inventory remaining (for a product)
   Availability (for a service)
   Lowest prices (with discounts and taxes factored in)
   Closest proximity to the customer's current location and to other vendors
   If the vendor and its locations are on a preferred list
   Vendors with high customer ratings
Public transportation availability (if the customer cannot provide transportation)
Calculation of the quantities of the goods that should be purchased from each vendor which is determined by:
   Price divided by units (weight, quantity, etc.) if possible, to determine the cost per unit (which makes comparisons easier)
   Amount of the goods the customer would like to purchase
   Availability of the goods in the size and volume at each vendor location
Determination of the order in which the vendors should be visited which is determined by:
   How close the vendor locations are to each other
   Customer's preferred routes
   Estimated time it takes to travel between locations
Computation of the recommended routes by which the vendors should be visited which is determined by:
   Commonly used linear programming and routing algorithms
Display of the vendor locations, total cost of purchases at each location, total trip time, and routes by which the customer should travel

Collectively, the outputs from the system are considered a recommended “shopping trip.” Each shopping trip has a base cost (the price of only the goods) and a total cost associated with it. The shopping trip with the lowest total cost is considered the primary recommendation to the customer. Customers can chose alternate shopping trips which may not save as much money but may be favorable for any number of personal reasons.

In one embodiment of the system, the total cost of the shopping trip can change in real-time if any of the variables change such as traffic conditions. Variables are continually evaluated by the system and if the total cost of any recommended shopping trip changes, the customer can be alerted and alternate recommendations provided. For example, if a vendor has run out of a product, a hair stylist has a backlog of customers, or traffic congestion develops, then the customer can be alerted and provided with alternate solutions in real-time. This alert can come in many forms. In one embodiment, the alert is presented on the customer's navigation system and an updated shopping list is presented. In another embodiment, the customer receives an email or text message to his or her mobile phone.

Once customers have completed their trip, they can input into the system which of the items on their shopping list were actually purchased, how much was purchased, and their satisfaction with the vendors they patronized. This data can be used to further provide recommendations in the future.

### BRIEF DESCRIPTION OF THE DRAWINGS

FIG. 1 is an input system and screen display that allows customers to provide personal shopping preferences.

FIG. 2 is a system and screen display that allows customers to search for particular types of goods in the customer's local area.

FIG. 3 is a graphical user interface display screen that shows a list of vendors selling specific goods in the customer's local area.

FIG. 4 is of a display screen that shows a customer's optimized shopping trip that has been based on customer preferences, data on goods and vendors, and location data.

FIG. 5 is a system output integrated into a navigation or mapping system to provide customers with a visual means of making an optimized shopping trip.

### DETAILED DESCRIPTION OF THE DRAWINGS

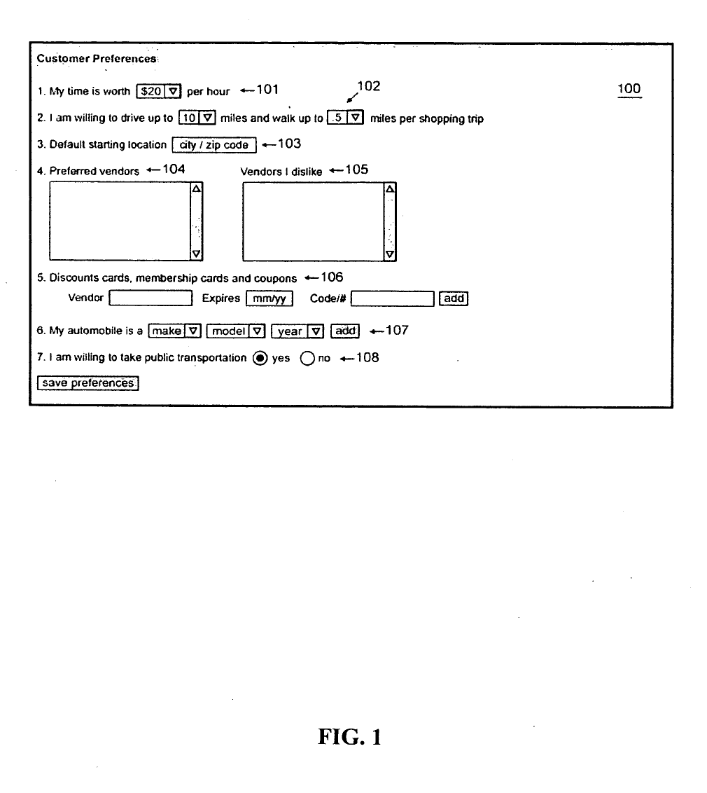

FIG. 1 is an illustration of an input system and screen display [100] that allows customers to enter personal shopping preferences. In implementing the system, the customer provides an estimated value of one hour [101] of his or her time. This information is used to determine how much time a customer should spend shopping for goods. For example, customers with high time values should spend less time traveling from one vendor to another if it means small savings.

Customers also specify how far they are willing to drive and walk [102] during a shopping trip. Older shoppers, for example, may decide that walking more than one half mile is too difficult.

The default starting location [103] may be a city and state combination or a zip code. If the system is part of a larger navigation system, then customers may not even need to provide this information. The default starting location might be a customer's home address with street information. This data point will be used to determine the origins of shopping trips.

Preferred vendors [104] are given preference when determining which locations should be recommended to customers. Disliked vendors [105] are not included in the recommended shopping trips or are given low priority.

Customers can optionally specify what discount cards, membership cards, rebates or coupons [106] they hold. These are applied and reduce the total costs to the customer.

Customers are also asked to specify what kinds of automobiles they drive [107] if any. This will be used to determine how much fuel they consume per mile. If an automobile consumes a large quantity of fuel, then the system will give higher priority to vendors in close proximity to the customer's origin. In addition, automobiles depreciate for each mile driven. Each automobile make, model and year depreciates a different amount and this will be used by the shopping trip optimization engine.

Finally, customers may specify that they are willing to provide public transportation [108]. The system will take public transit costs, routes and schedules into consideration when optimizing the shopping trip. This variable is important in markets such as New York or Chicago where customers often do not own automobiles and may have to walk or use taxis, buses or subways.

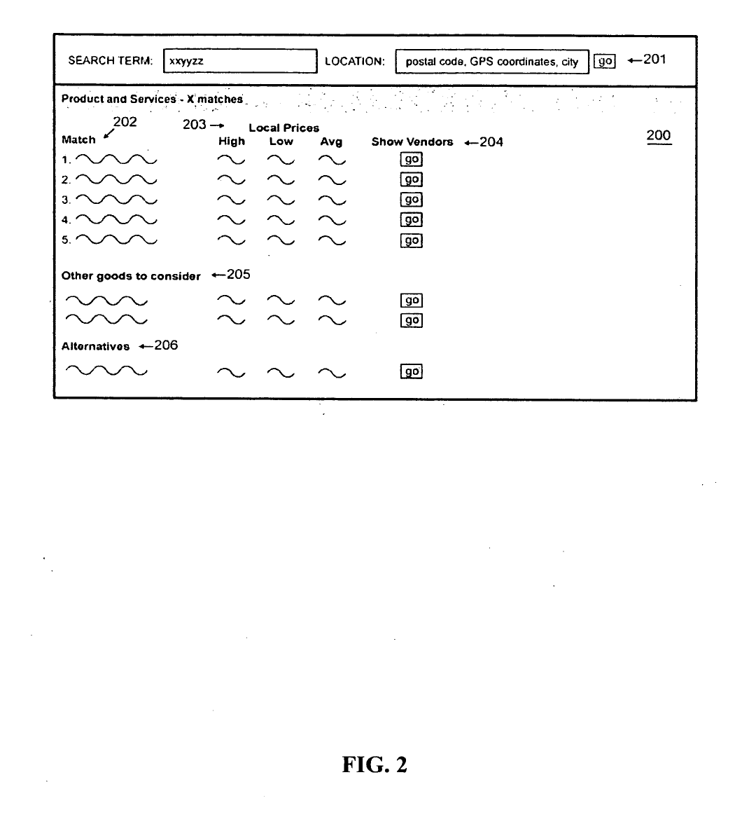

FIG. 2 is an illustration of a screen display of the system that allows customers to search for particular goods [200]. Customers can enter in a search term and their location [201]. Products and services that are sold in the local area specified (and within the radius specified by the customer preferences) are found and displayed to the customer [202]. The search may be conducted on the Internet using an available search engine.

For example, consider that the customer searches for “haircut.” Several matches might be returned including, “women's haircut” and “haircut, shampoo and blow-dry.” The high, low and average price of the service is shown [203]. Customers can then optionally request a specific list of vendors who perform that service [204]. The system also may recommend which vendor is ideal.

Customers also are presented with complementary goods [205] which the customer may also want to consider. The system also presents alternative goods [206] which may provide more value to the customer.

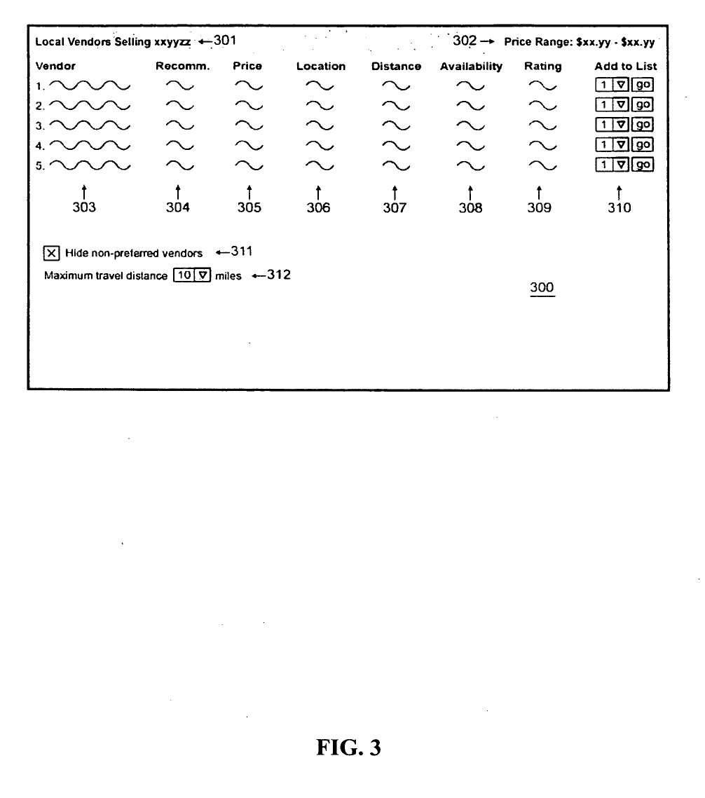

FIG. 3 is a screen display used in the system showing a list of vendors who are selling the selected goods in the local area [300]. The goods the customer is trying to locate is shown at the top of the display [301]. The price range (low to high) also is shown [302]. The vendors carrying the goods are shown in the first column [303]. In addition, the system also recommends various vendors based on customer feedback ratings or ratings obtained from a third party [304]. These ratings are based on how vendors are perceived in terms of product quality, convenience, selection, average prices and customer service.

In one embodiment of the system the current price of the specified goods is displayed [305]. In another embodiment, the average price of the goods over time may be shown. The distance to the vendor's location [306] is also shown. A location may be the street address of a store, a location in a shopping mall, or some other location designation. The distance to the location [307] is provided to the customer so they understand how far they must travel from their default location (or origin) to the vendor. In addition, the availability of the goods is displayed [308]. Availability might include the number of units of the product in stock or the time slots available if it is a service. The rating [309] is a customer feedback rating such as the number of stars a vendor has received. Customers can add a specific vendor to their shopping list [310] if they have a strong desire to purchase the goods from that vendor. They can also specify the quantity of the goods they wish to add to their list. Customers optionally can allow the system to choose the vendor for them.

Some customers may have preferred vendors they have specified when inputting their customer preferences. In this embodiment of the system, non-preferred vendors can be left out of the vendor list [311].

Thus, the customer may create a virtual shopping list by use of the system and method of the present invention.

Customers can also specify if they are willing to travel farther [312] than originally specified. Choosing this option may allow the system to find additional vendors carrying the goods.

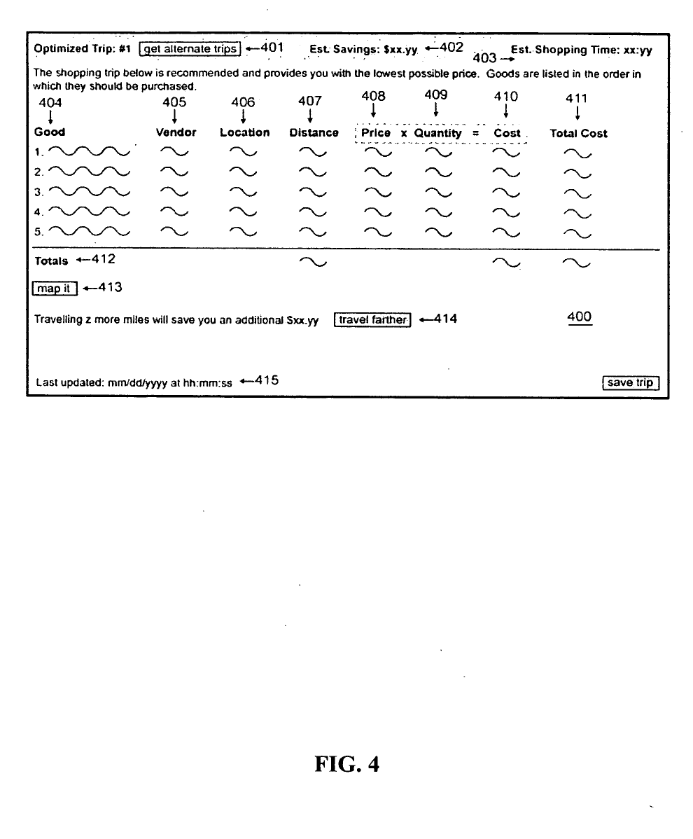

FIG. 4 shows a customer's optimized shopping trip [400] in a screen display produced by the system. Customers may decide to use the first trip given to them or can request an additional trip [401]. When requesting an additional trip, customers may decide to change one or more of the variables. An example would include changing the distance the customer is willing to travel or the addition of a time constraint.

The customer is presented with a savings estimate [402], which is the difference between the total cost [412] and the average cost of the goods at all vendors in the local area. For example, if the optimized cost of the goods is $100.00 and the average cost of the same goods in the local area is $125.00, then the estimated savings would be $25.00. This mechanism provides a benchmark that gives customers an idea of how much value the system is providing to them. Customers also can see the estimated time required to complete the shopping trip [403].

In one embodiment of the system, the optimized shopping trip lists goods in the order they should be purchased [404]. The vendor [405] carrying the goods and [406] and location of the vendor are shown. The distance [407] may also be provided.

The purchase cost of the goods [410] is calculated using the price [408] and quantity [409]. The total cost of the goods [411] is calculated using the method described above and will almost always be greater than the purchase price.

Customers are shown totals [412] for columns such as distance, purchase cost and total cost. Also, in an embodiment of the invention, customers can chose to map [413] the shopping trip on a graphical display. Customers are given the option to travel farther [414] in order to save even more money if such savings are applicable. Finally, because the shopping trip may be updated in real-time, a timestamp [415] is provided.

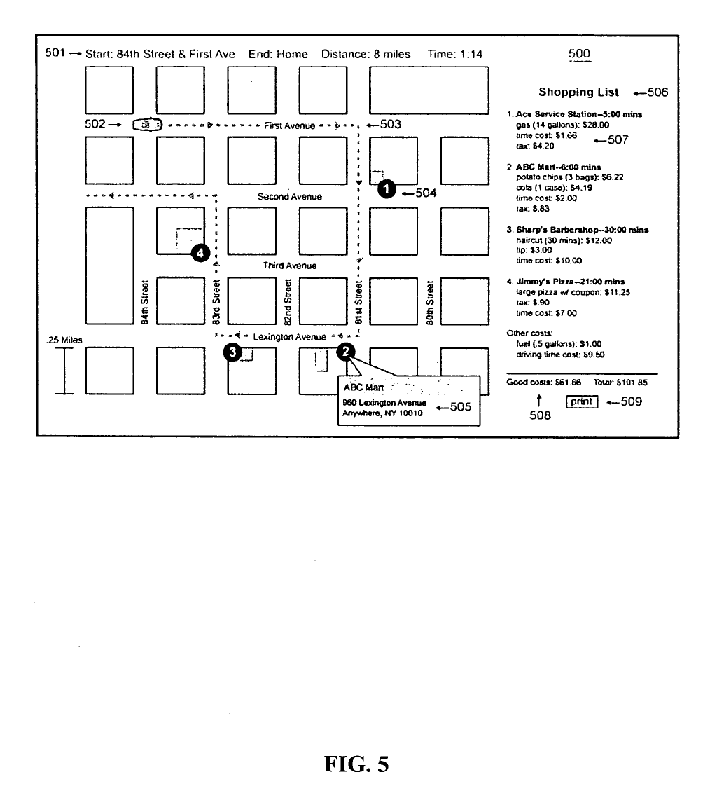

FIG. 5 shows an embodiment of the system in which a shopping trip is integrated into a mapping or navigation system [500]. At the top of the display is the starting address and ending address [501] as well as the estimated distance and trip time. The customer's current location [502] is shown as well as the proposed travel route [503]. Along the route are the vendor locations [504] that the system recommends the user patronize. In this embodiment of the invention, the proposed stops are numbered. Customers are able to get more information on a location [505] by clicking on the location, tapping on a screen, using spoken commands or by another known method. For example, a navigation system may use voice recognition to allow a customer to request more information such as the exact street address or hours of operation. The system could then use an artificial voice to speak the information back to the customer.

The system may also present the shopping list [506] to the customer. The list includes the goods [507] in the order they should be purchased. Each listing would specify the location of the goods, the estimated time it would take to purchase the goods, its purchase cost and total costs. The shopping list would also present totals [508] for the purchase costs and total costs. In this embodiment of the system, the customer has the option to print [509] the map and shopping list recommendations.

Various changes and modifications may be effected by one skilled in the art without departing from the spirit and scope of the invention. For example, the invention could be used in connection with services, and the term “goods” should be understood to include both goods and services.

What is claimed is:

1. A method for facilitating a purchase transaction, comprising:
storing vendor information, goods availability, goods attributes, and goods prices for a plurality of vendors;
receiving a search query for goods desired by a customer;
performing a search for the goods;
displaying search results with price information;
receiving confirmation from the customer as to which of the goods the customer wants to add to a virtual shopping list; and
allowing customers to either select vendors from whom they would like to purchase the goods or choosing the vendors so as to minimize total purchasing cost to the customer.

2. The method of claim 1, further comprising comparing prices for the same goods provided by many vendors.

3. The method of claim 2, wherein the price comparison is made between different quantities of the goods.

4. The method of claim 1, wherein the vendors are characterized by a geographic designation.

5. The method of claim 1, further comprising determining the customer's geographic location at the time the customer wishes to embark on a shopping trip.

6. The method of claim 1, further comprising selecting which goods identified in the search should be included in the customer's virtual shopping list.

7. The method of claim 1, further comprising displaying vendor locations, goods prices, and purchase costs on a virtual map of a geographic area.

8. The method of claim 7, further comprising giving lower priority to or excluding vendors who have poor reviews from customers or who the customer has chosen not to do business with.

9. The method of claim 1, further comprising rating satisfaction by customers with vendor in terms of product quality, quality of customer service, convenience of location, total purchase cost, or product selection.

10. The method of claim 9, wherein the vendors whose ratings do not meet a customer's minimum level of satisfaction are excluded from the virtual shopping list.

11. The method of claim 1, further comprising printing a copy of the virtual shopping list and a map of vendor locations.

12. The method of claim 1, further comprising storing the customer's preferred vendors and using search information to determine which vendors should be given priority in future search results.

13. The method of claim 1, further comprising proposing substitute and complementary goods that might interest the customer.

14. A method of determining an optimal travel route by which customers can purchase goods at the lowest total cost, comprising:
showing goods prices for a plurality of vendors;
receiving and storing customer information including customer's perceived time value of money, automobile make and model, time restraints, and default geographic location;
receiving traffic conditions, weather conditions and other data for the local geographic area;
receiving a search query for goods desired by a customer;
performing a search for the goods;
displaying search results arranged by geographic location with price information for the local area;
receiving confirmation from the customer as to which of the goods the customer wants to add to a virtual shopping list;
determining the ideal route the customer should take to minimize the total cost of purchasing the goods on the virtual shopping list; and
displaying to the customer a virtual map of the geographic area with identified vendor locations, which goods are available at each location, the total cost of purchasing the goods at each location, and the preferred routes to use that will result in the lowest total purchase cost.

15. The method of claim 14, further comprising estimating the customer's time value of money that will be used to determine the maximum distance the customer would be willing to travel to purchase substitute goods.

16. The method of claim 14, further comprising displaying vendor locations and goods prices on a virtual map of the geographic area

17. The method of claim 14, further comprising proposing alternative routes to the customer, and updating the total purchase cost accordingly.

18. The method of claim 17, further comprising updating the total purchase cost in real time, as variables change, such as traffic condition or the goods no longer are in stock at the vendor.

19. The method of claim 14, further comprising proposing additional routes, in real time, as variables change.

20. The method of claim 14, wherein the customer can exclude certain vendors from the proposed shopping trip routes due to unwillingness to patronize those vendors.

21. The method of claim 14, further comprising printing a copy of the virtual shopping list and map.

22. The method of claim 14, further comprising storing customer's preferred vendors and routes and using such information to determine which vendors and routes should be given priority in future search results.

23. The method of claim 14, further comprising proposing substitute and complementary goods that might interest the customer.
